(19) United States
(12) Patent Application Publication
(10) Pub. No.: US 2017/0372393 A1
(43) Pub. Date: Dec. 28, 2017

(54) Method, Apparatus and Computer-Readable Medium for Question Answer Advertising

(71) Applicant: Docunexus, Inc., East Elmhurst, NY (US)

(72) Inventor: Shekhar Pradhan, East Elmhurst, NY (US)

(21) Appl. No.: 15/629,431

(22) Filed: Jun. 21, 2017

Related U.S. Application Data
(60) Provisional application No. 62/353,326, filed on Jun. 22, 2016.

(51) Int. Cl. G06Q 30/06; G06Q 30/02

(52) U.S. Cl. CPC G06Q 30/0613; G06Q 30/0277

(57) ABSTRACT

Embodiments of the present disclosure provide a method, apparatus, and computer-readable medium for advertising. An exemplary method includes displaying an advertisement, wherein the advertisement is operable to receive an input and receiving an input. The method further includes in response to the receiving, determining whether the input is appropriate; and in response to determining that the input is appropriate, determining a response to the input based on a plurality of information in a digital repository.

### FIELD OF THE INVENTION

Exemplary embodiments of the present disclosure relate to a method, apparatus, computer-readable medium, and system for digital advertisement. Exemplary embodiments of the present disclosure relate more particularly to displaying an interactive digital advertisement.

### DESCRIPTION OF RELATED ART

Online advertising, also known as online marketing, interne advertising, or web advertising, is a form of marketing and advertising, which uses the Internet to deliver promotional marketing messages to consumers. It includes email marketing, search engine marketing, social media marketing, many types of display advertising (including web banner advertising), and mobile advertising. Similar to other advertising media, online advertising frequently involves both a publisher, who integrates advertisements into its online content, and an advertiser, who provides the advertisements that is displayed on the publisher's content. However, there is a need for enhanced advertising.

### BRIEF SUMMARY OF THE INVENTION

In view of the foregoing, it is an object of the present disclosure to provide a method, apparatus, and computer-readable medium for advertising.

A first exemplary embodiment of the present disclosure provides a method that includes capturing a question (or query) entered by the user, either by speaking or typing the question in a question box in an advertisement as displayed on a user equipment (UE) or display platform. The method further includes sending the question to a software program installed either on a remote server or on a computer connected to the display device (collectively referred to as ‘computational platform’), and determining, by the computational platform, whether the question is appropriate. If appropriate, the method includes determining an answer to the question either from a digital repository of stored documents or from a set of documents compiled on the fly from a larger collection of documents, such as the collection of documents posted on the Internet. Embodiments of documents include textual, sound clips, or video clips. If an answer is found, the method includes playing (if in the form of a video or sound clip) or displaying the found answer in an area of the advertisement. If an answer is not found, embodiments provide that a message can be displayed in the advertisement indicating that an answer cannot be found. Embodiments also provide that the UE can display a related advertisement or a question for which there is a known answer in the advertisement.

A second exemplary embodiment of the present disclosure includes a user submitting a question to an advertisement by speaking into a microphone built into the display platform on which the advertisement appears. In this embodiment the answers appears in the form of a video clip which is auto-played to create the sense of a conversation.

A third exemplary embodiment of the present disclosure provides a method for advertising. The method includes displaying an advertisement, wherein the advertisement is operable to receive an input, and receiving an input. The method further includes in response to the receiving, determining whether the input is appropriate, and in response to determining that the input is appropriate, determining a response to the input based on a plurality of information in a digital repository.

A fourth exemplary embodiment of the present disclosure provides an apparatus for advertising. The apparatus includes at least one processor and a memory storing computer program instructions executable by the at least one processor, wherein the memory with the computer program instructions and the processor are configured to cause the apparatus to at least display an advertisement, wherein the advertisement is operable to receive an input. The memory with the computer program instructions and the processor are further configured to cause the apparatus to receive an input, in response to the receiving, determining whether the input is appropriate, and in response to determining that the input is appropriate, determining a response to the input based on a plurality of information in a digital repository.

A fifth exemplary embodiment of the present disclosure provides a non-transitory computer-readable medium tangibly storing computer program instructions which when executed by a processor, cause the processor to at least display an advertisement, wherein the advertisement is operable to receive an input, and receive an input. The processor is further caused to in response to the receiving, determining whether the input is appropriate, and in response to determining that the input is appropriate, determining a response to the input based on a plurality of information in a digital repository.

The following will describe embodiments of the present disclosure, but it should be appreciated that the present disclosure is not limited to the described embodiments and various modifications of the invention are possible without departing from the basic principles. The scope of the present disclosure is therefore to be determined solely by the appended claims.

### BRIEF DESCRIPTION OF THE SEVERAL VIEWS OF THE DRAWING(S)

FIG. 1 presents an exemplary advertisement suitable for performing exemplary embodiments of the present disclosure.

FIG. 2 presents an exemplary advertisement with a question or input entered suitable for performing exemplary embodiments of the present disclosure.

FIG. 3 presents an exemplary advertisement in response to a question or input suitable for performing exemplary embodiments of the present disclosure.

FIG. 4 presents a simplified signaling diagram between devices suitable for use in practicing exemplary embodiments of this disclosure.

FIG. 5 presents another signaling diagram in accordance with exemplary embodiments of the present disclosure.

FIG. 6 presents a simplified logic flow diagram in accordance with a method, apparatus, and computer-readable medium for performing exemplary embodiments of this disclosure.

FIG. 7 presents a simplified block diagram suitable for performing exemplary embodiments of the present disclosure.

FIG. 8 presents a logic flow diagram in accordance with a method, apparatus, and computer-readable medium for performing exemplary embodiments of the present disclosure.

### DETAILED DESCRIPTION OF THE INVENTION

Embodiments of the present invention generates an answer in an advertisement to a question generated by the viewer in the advertisement. Embodiments of the present disclosure advances the art of interactive digital advertising by allowing users to pull an advertising message from an advertiser in the form of an answer to a question posed by the user as opposed to a question posed by the advertisement.

Advantages of the present disclosure include the fact that advertisers can supply information in response to a question of the user/viewer and thus the user/viewer is more likely to pay attention to the message. Since advertisers are constantly battling for the attention of consumers this invention is very useful to them because embodiments of the present disclosure help maintain the consumer's attention. The advantage to consumers is that they can instantly get the information they want from advertisers without having to visit the advertisers' website.

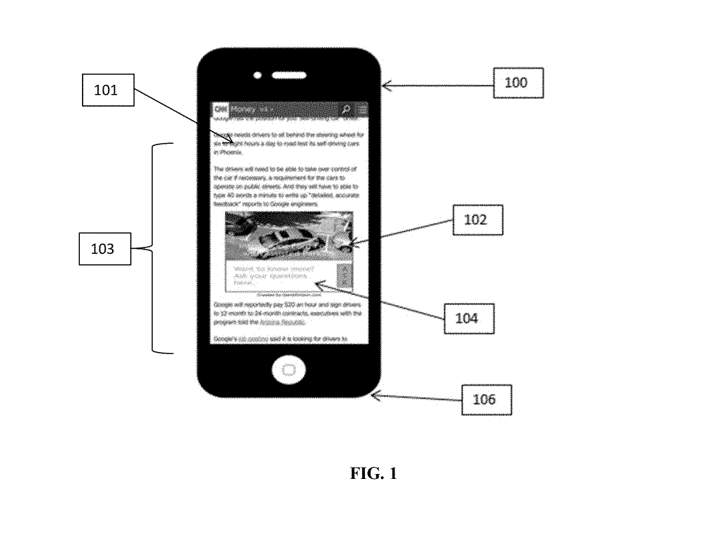

Referring to FIG. 1, shown is an exemplary advertisement as displayed on a user equipment (UE) 100 having a digital advertisement 102 displayed on a client browser, which shows a question box area 104 where a user may input a question, either by typing or by activating the microphone 106 of the digital device on which the advertisement 102 is displayed and speaking into the microphone 106. For the case that a user inputs a question with microphone 106, a transcription of the input question is displayed in question box area 104. The user can modify the transcription of the input question within question box area 104 as desired. Embodiments of UE 100 include any smart phone, mobile phone, computer, tablet, wearable device (e.g., smart watch), desktop, personal computer, and the like. An exemplary UE 100 includes a display 101, a user interface 103, a processor 105, a memory 107 storing computer program instructions, a transmitter, and a receiver. UE 100 is operable to display an advertisement over an internet connection, receive user inputs via the user interface 103 (text or audio) and is able to transmit and receive data through wired or wireless connections.

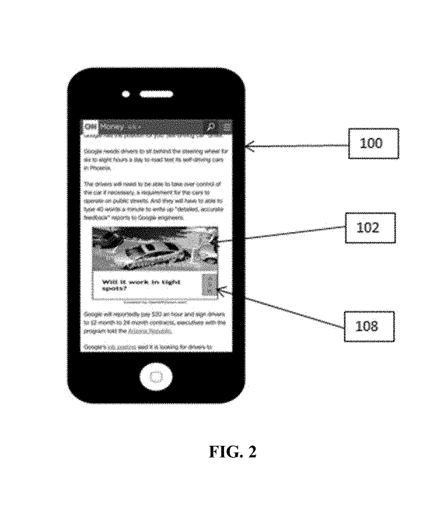

Upon entering a question and hitting the ASK button 108 as shown in FIG. 2, the input in the question box is sent to a software program on a remote server 110 to determine if the question is inappropriate, where the criteria for inappropriateness may vary from application to application. An exemplary inappropriate question includes a question that is obscene, hateful or irrelevant to the product or service that is the subject of the advertisement. In another example, a question may be determined to be inappropriate if it is an attempt to promote another product or service different from the subject of the advertisement. A question is appropriate if it is determined to not be inappropriate.

If the question is determined to be inappropriate then a message to that effect is displayed in the answer section 112 (which can replace the question box area 104 in the displayed advertisement). For example, if a question is determined to be inappropriate, the advertisement can display text stating that the question is inappropriate and that the user should ask a different question. An example response to an inappropriate question could include text stating, “Our system has determined this question to be inappropriate. Please ask another question.”

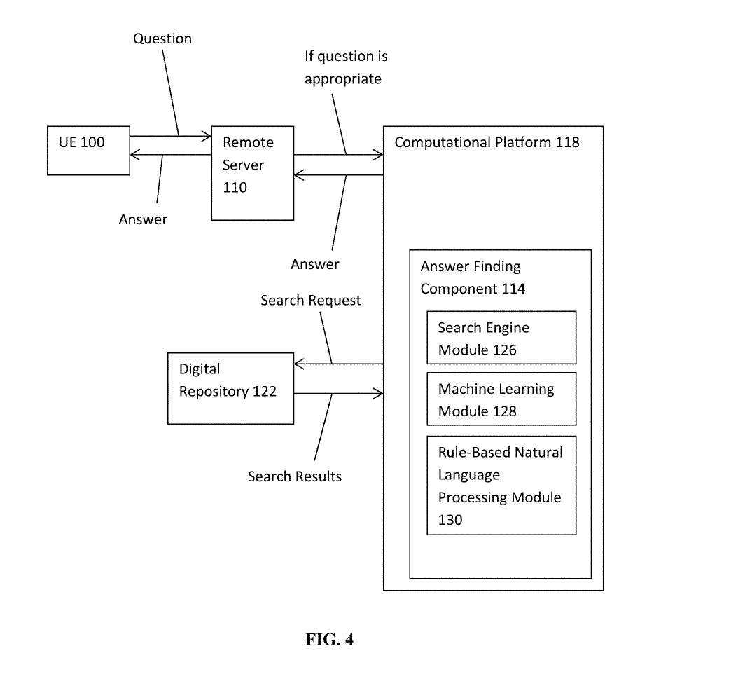

Referring to FIG. 4, shown is an exemplary signaling diagram between devices suitable for answering a question. Shown in FIG. 4 is UE 100, which is operable to display an advertisement and receive a user's questions via its user interface. Upon receipt of a user's question, UE 100 is operable to transmit the question to remote server 110. UE 100 is operable to send and receive data or information with Remote server 110 through wired or wireless connections. UE 100 is also operable to communicate with remote server 110 through the internet. Remote server 110 is operable to determine whether a question is appropriate, to transmit an appropriate question to the computational platform 118, and to transmit an answer to UE 100. Computational Platform 118 is operable to receive a question and to search digital repository 122 to find an answer to the question. Digital repository 122 can include a collection of website, predetermined information, documents, and the like which may include answers to commonly asked questions pertaining to a given product that is being advertised.

In practice, once a question is determined to be appropriate, it is sent from UE 100 to Remote Server 110, and from Remote Server 110 to a series of modules stored on computational platform 118 collectively referred to as the Answer Finding Component 114. Exemplary embodiments of computational platform 118 include one or more servers each having at least one processor and at least one memory storing computer program instructions. Exemplary embodiments of computational platform 118 are operable to communicate with remote server 110 and/or UE 100 and digital repository 122 through wired or wireless connection (such as through the internet). It should also be appreciated that embodiments include Computational Platform 118 being an element of Remote Server 110.

The Answer Finding Component 114 is operable to find an appropriate answer from a collection of documents 120 that are stored in Digital Repository 122 or from a set of documents compiled by the Answer Finding Component 114 in response to the question from a larger collection of documents, such as the collection of documents posted on the Internet 124. Digital Repository 122 may be maintained or stored within a memory within Computational Platform 118 and/or Answer Finding Component 114. In another embodiment, Digital Repository 122 is a separate from Computation Platform 118 (as depicted in FIG. 4). Embodiments of Answer Finding Component 114 include that it can include at least one processor and at least one memory storing computer program instructions. Embodiments of Answer Finding Component 114 are operable to communicate with Digital Repository 122, Computational Platform 118, Remote Server 110 and UE 100 through wired or wireless connections.

Embodiments provide that an appropriate answer can be determined by the UE 100, the Computational Platform 118, Answer Finding Component 114, or the remote server 110. Embodiments further provide that an appropriate answer can be determined by a combination of any one of UE 100, Computational Platform 118, and Remote Server 110. An answer to a quest that is determined to be appropriate can be determined (i) on an as needed basis (also known as on the fly) (e.g., by the UE 100, Computational Platform 118, or Remote Server 110) in response to a question from a user, (ii) prior to receiving a question from a user as part of a collection of predetermined answers and questions, or (iii) a combination of an as needed answer with some predetermined aspects.

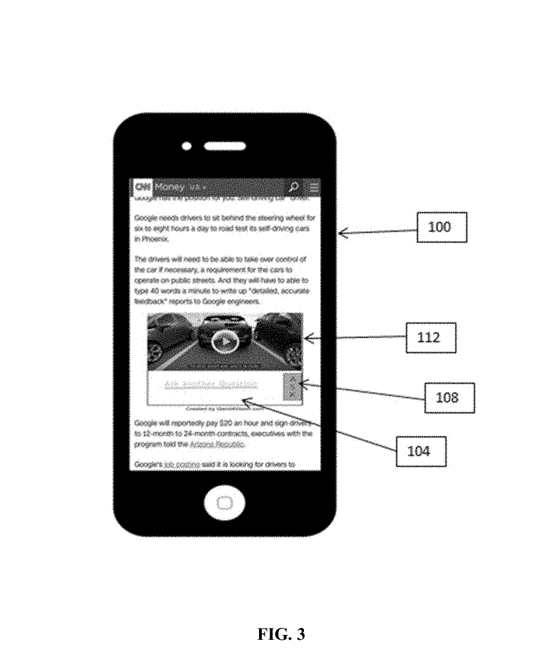

The series of modules maintained by Answer Finding Component 114 which are operable to find the answer among a collection of documents maintained in Digital Repository 122 may include a search engine module 126, a machine learning module 128, and a rule-based natural language processing module 130. The search engine module 126 is operable to search the digital repository 122, the interne, or other data base for possible answers to questions received from users. The machine learning module 128 is operable to improve the search results of the search engine module 126 by using prior search results and answers to commonly asked questions as a basis for future questions. The rule-based natural language processing module 130 is operable to convert or understand the meaning of similarly worded questions for searching. If an answer to the input or question is found by Answer Finding Component 114, it is sent either through Remote Server 110 to UE 100 or directly to UE 100 by Computational Platform 118. UE 100 then displays within display 103 determined answer within the advertisement. FIG. 3 illustrates the answer in the form of a video that is displayed by display 103 within the advertisement 102.

In one embodiment, the input to the question box 104 is spoken by the user rather than input in text form. Embodiments of UE 100 are operable to transcribe the question or input into text, which is displayed in the question box 104. UE 100 then sends the transcribed input, possibly after correcting it after it is transcribed and displayed within question box 104, to the Answer Finding Component 114. Answer Finding Component 114 determines an answer to the question from the Digital Repository 122 of documents. In this embodiment, the database of documents are in the form of video clips. The Answer Finding Component 114 sends a video answer to the question to Remote Server 110 and UE 100. The vide answer is then displayed by UE 100 such that the user can view the video within the advertisement. It should be appreciated that embodiments of a video or audio answer include the video or audio answer automatically playing on UE 100 in response to receiving the answer or they can display a prompt for the user to interact with before playing the audio or video answer. For instance, the audio or video answer may include an image of a play button that can be selected by the user to initiate playing of the audio or video answer in advertisement 102. In yet another embodiment the repository of documents contains textual documents and the answer is in a textual form and is displayed in that form in the answer area of the advertisement 102.

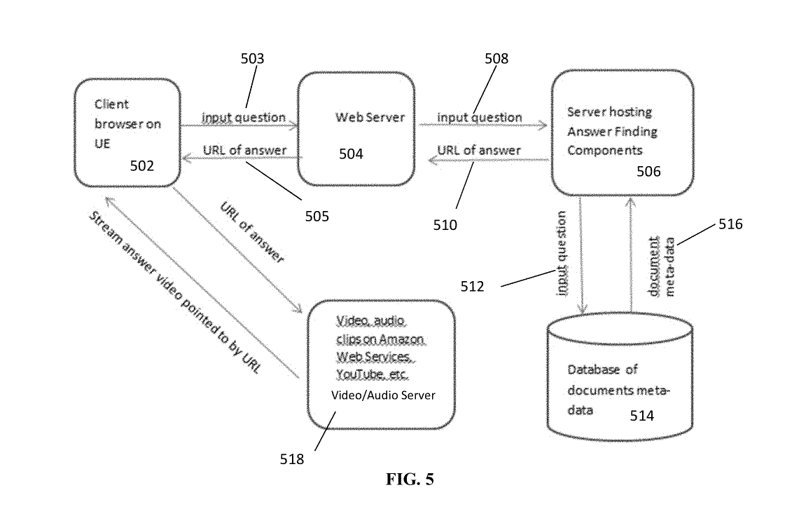

FIG. 5 depicts another signaling diagram applicable for the instance that the answer to a question from a user in an advertisement is in the form of a video or audio clip. Shown in FIG. 5 is the client browser 502 on UE 100, which can display an advertisement. The client browser is operable to receive a user's input/question. UE 100 is operable to transmit the input question to the web server 504 via communication line 503. The web server 504 can include at least one processor and at least one memory storing computer program instructions. Web server 504 is operable to receive an input question and to transmit an answer to the UE 100 via communication line 505, which can be displayed in the advertisement. The web server 504 can also transmit the input question via communication line 508 to a server 506 hosting the answer finding components (e.g., computational platform 118 and/or answer finding component 114). The server 506 is operable to receive the input question and to transmit an answer to the web server via communication line 510. The server 506 is also able to transmit the input question via communication line 512 to the database of documents metadata 514 to determine an answer to the question and receive an answer to the input question from the database of documents metadata via communication line 516. In one embodiment, a URL is returned to the client browser 502 on UE 100 in response to the user's question in the advertisement. Upon receiving the URL, the client browser 502 on UE 100 makes a request to the video server 518 to begin streaming the video/audio referenced in the URL on UE 100. The video server 518 (e.g., a YouTube video) will then stream the video/audio, which provides an answer to the question in video or audio format. The answer video/audio answer is played on UE 100 either automatically or upon selection of an element on UE 100 user interface.

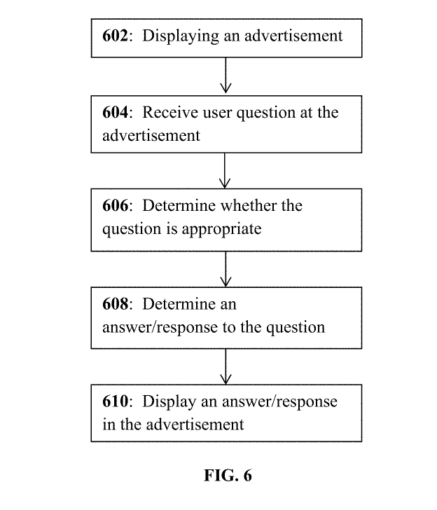

Reference is now made to FIG. 6, which depicts a simplified logic flow diagram in accordance with an exemplary process or method of the present disclosure. The process begins at block 602 with displaying an advertisement. Then at block 604 the UE receives a user question at the advertisement. At block 606, the process continues with determining whether the question is appropriate. Next at block 608 it relates to determining an answer/response to the question. Finally, at block 610 the process ends with displaying an answer/response in the advertisement. It should be appreciated that embodiments include the processes described herein being repeated one or more times within the same advertisement. Accordingly, the processes described with reference to FIGS. 4, 5, 6, 7, and 8 can be repeated one or more times within the same advertisement.

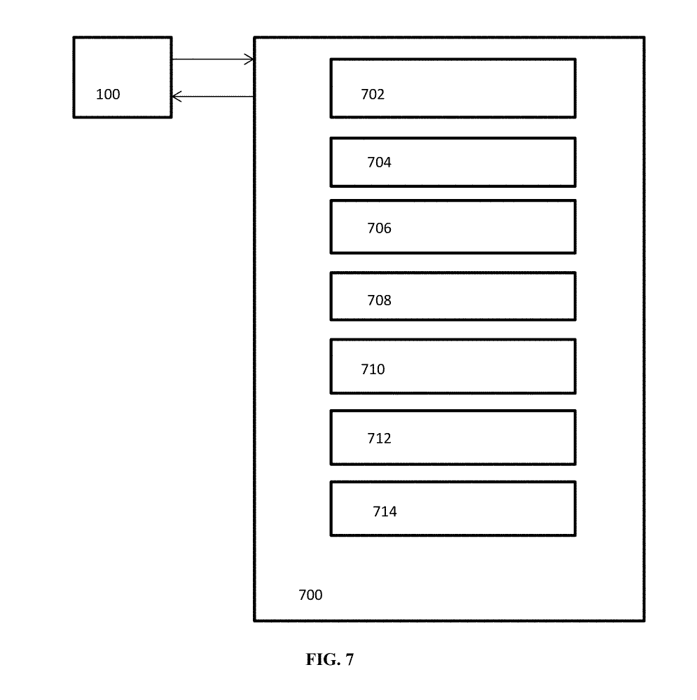

Referring now to FIG. 7 is an alternative block diagram in accordance with an alternative embodiment of the present disclosure. As depicted in FIG. 7, after it is determined that a question is appropriate, the input or question is sent from UE 100 through a SmallTalk component 702 maintained in the computational platform 700, which determines if the input is not a question, but can be classified as conversational language. For example, conversational language can include words such as “hi” or “thank you” or “great response.” It should be appreciated that a question be sent directly to or indirectly (e.g., through a network or the internet) to SmallTalk component 702. In case the SmallTalk component 702 determines that the input is conversational language, the SmallTalk component 702 generates a response based on a collection of predetermined conversational responses stored within SmallTalk component 702. This response is returned by the algorithm and the algorithm is terminated for that input.

If the input is determined to not be conversational language by the SmallTalk component 702, the input is sent to a Rules Engine 704. The Rules Engine 704 includes a set of condition-action rules. These rules can vary from application domain to application domain. If the input matches the condition part of a condition-action rule, the action part of the rule is executed by the Rules Engine 704. The action part of a condition-action rule will typically involve retrieving a response to the input from a collection of pre-determined answers. In another embodiment of a condition-action rule, the action part may have code to create a database SQL query, which will then be executed to retrieve an answer to the question. In yet another embodiment of a condition-action rule, the action part may contain code to compile a response to the input on the fly based on material available on the internet. The answer found by the Rule Engine 904 is returned by the algorithm and the algorithm is terminated for that input.

If the input or question is not recognized by any rules in the Rule Engine 704, the input is sent to the Search Questions Engine component 706. The Search Questions Engine component 706 searches among a collection of predetermined questions for which there are predetermined answers. The collection of predetermined questions can vary from application domain to application domain. Each question search result includes a score as to the likelihood of its relevance to the question. The Search Questions Engine component 706 returns a number of question search results with score that are above a predetermined threshold value. Both the number of search results to be returned and the threshold value can be configured and can vary from application domain to application domain.

Next the input and the top search results are sent to a Machine Learning for Questions (MLQ) component 708. The MLQ component 708 compares the input to each of the search results and returns a score. The score represents the degree of confidence it has that the input means the same as the search result. The MLQ component 708 returns the search result with the highest confidence value if is above a predetermined threshold value. The threshold value can be configured and vary from application domain to application domain.

If the MLQ component 708 does not recognize any of the search results as having the same meaning as the input (with a confidence value above the predetermined threshold), the input is sent to Search Answers Engine component 710. The Search Answers Engine component 910 searches among a collection of answers. This collection of answers can vary from application domain to application domain. Each question search result includes a score as to the likelihood of its relevance to the question. The Search Answers Engine component 710 returns a number of question search results with score that are above a predetermined threshold value. Both the number of search results to be returned and the threshold value can be configured and can vary from domain to domain.

Next the input and the top search results are sent to a Machine Learning for Answers (MLA) component 712. The MLA component 712 compares the input and each of the (answer) search results and returns a score which represents the degree of confidence it has that the answer is a correct answer to the input. The MLA component 712 returns the search result with the highest confidence value if it is above a predetermined threshold value. The predetermined threshold value can be configured and vary from application domain to application domain.

The result returned by the MLQ component 708 or the result returned by the MLA component 712 (for the case that no result is returned by MLQ component 708) are next sent to the Rejection Engine 714. The Rejection Engine 714 is operable to determine if there are any reasons to reject the result based on considerations specific to the application domain.

If any (question) result is obtained by MLQ component 708 and is not rejected by MLA component 712, the answer associated with the question is sent to the user at the UE 100. If no answer is determined, a failure message is returned to indicate that the algorithm could not find an appropriate answer to the input.

It should be appreciated that embodiments of computation platform 700 may include one or more processors, one or more memories each operable to store computer program instructions for performing embodiments of the present disclosure. It should also appreciated that while each element 702-714 depicted in FIG. 7 is maintained within computational platform 700, embodiments include any one or more of these elements being separate from computational platform 700.

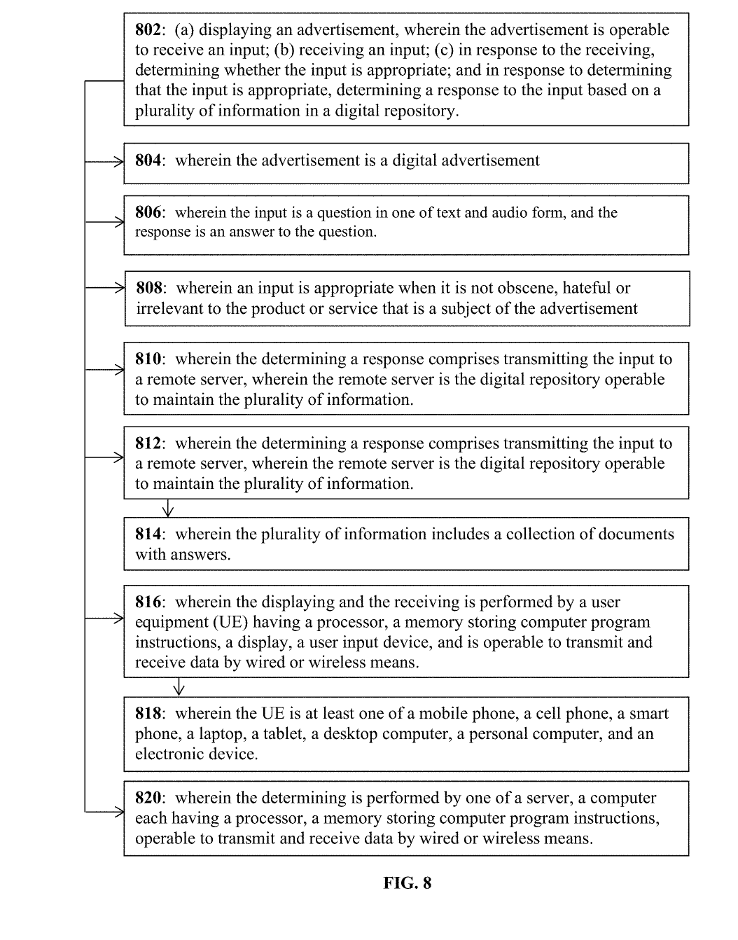

Reference is now made to FIG. 8, which presents a logic flow diagram in accordance with a method, apparatus and computer-readable medium for performing exemplary embodiments of this disclosure. Block 802 presents (a) displaying an advertisement, wherein the advertisement is operable to receive an input; (b) receiving an input; (c) in response to the receiving, determining whether the input is appropriate; and in response to determining that the input is appropriate, determining a response to the input based on a plurality of information in a digital repository. Following block 802 is block 804 which specifies wherein the advertisement is a digital advertisement.

Some of the non-limiting implementations detailed above are also summarized at FGI. 8 following block 804. Block 806 relates to wherein the input is a question in one of text and audio form, and the response is an answer to the question. Block 808 wherein an input is appropriate when it is not obscene, hateful or irrelevant to the product or service that is a subject of the advertisement. Block 810 then states wherein the determining a response comprises transmitting the input to a remote server, wherein the remote server is the digital repository operable to maintain the plurality of information. Block 812 indicates wherein the determining a response comprises transmitting the input to a remote server, wherein the remote server is the digital repository operable to maintain the plurality of information. Block 814 then relates wherein the plurality of information includes a collection of documents with answers.

Following block 814, block 816 states wherein the displaying and the receiving is performed by a user equipment (UE) having a processor, a memory storing computer program instructions, a display, a user input device, and is operable to transmit and receive data by wired or wireless means. Then block 818 specifies wherein the UE is at least one of a mobile phone, a cell phone, a smart phone, a laptop, a tablet, a desktop computer, a personal computer, and an electronic device. Next, block 820 indicates wherein the determining is performed by one of a server, a computer each having a processor, a memory storing computer program instructions, operable to transmit and receive data by wired or wireless means.

The logic flow diagram of FIG. 6 and FIG. 8 may be considered to illustrate the operation of a method or a result of execution of computer program instructions stored in a computer-readable medium. The logic diagram of FIG. 6 and FIG. 8 may also be considered a specific manner in which components of a device are configured to cause that device to operate, whether such a device is a mobile phone, cell phone, smart phone, laptop, tablet, desktop or other electronic device, or one or more components thereof. The various blocks shown in FIG. 8 may also be considered as a plurality of coupled logic circuit elements constructed to carry out the associated function(s), or specific results of strings of computer program instructions or code stored in memory.

Various embodiments of the computer-readable medium include any data storage technology type which is suitable to the local technical environment, including but not limited to semiconductor based memory devices, magnetic memory devices and systems, optical memory devices and systems, fixed memory, removable memory, disc memory, flash memory, dynamic random-access memory (DRAM), static random-access memory (SRAM), electronically erasable programmable read-only memory (EEPROM) and the like. Various embodiments of the processor include but are not limited to general purpose computers, special purpose computers, microprocessors digital signal processors and multi-core processors.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

### Embodiment 1

A system and method for advertising comprising: (a) an advertisement displayed on a “display platform” which has a method for asking and displaying a question submitted by a viewer, (b) which advertisement has a method for capturing the submitted question and sending the question over a network to a software program for (i) determining whether the question is appropriate, (ii) if the question is found to be appropriate, searching for an answer to the question in a digital repository, (c) transmitting the answer over a network to the display platform, (d) displaying the answer in the advertisement on the display platform, (e) making it possible to ask another question in the advertisement on the display platform.

### Embodiment 2

The method of Embodiment 1, in which an advertisement displayed on a display platform has either or both an editable question box where a question can be typed or modified and a method for entering audio input using a microphone installed on the display device or attached to the display device or associated with the display device through a wireless connection.

### Embodiment 3

The method of Embodiment 1, in which if the input (question) is entered by using a microphone, the display device captures the audio input and transcribes it as text if it has the computational resources to achieve such tasks.

### Embodiment 4

The method of Embodiment 1, in which if the display device lacks the computational resources to transcribe the audio input as text, the audio input is transmitted through a network to a remote server where the audio input is transcribed as text on a computational platform, such as a server, and the text is transmitted back to the display device through a network.

### Embodiment 5

The method of Embodiment 1, in which the audio input, transcribed as text, is displayed as text in the question box.

### Embodiment 6

The method of Embodiment 1, in which there is a mechanism for transmitting the text displayed in the question box area to the Answer Finding Component on a computational platform when a request to transmit is initiated.

### Embodiment 7

The method of Embodiment 6, in which there is a mechanism for initiating a request to transmit the text displayed in the question box area to the Answer Finding Component by pressing a Submit or Ask button on the Display Unit.

### Embodiment 8

The method of Embodiment 1, in which there is a mechanism in the Answer Finding Component to determine whether the submitted question is appropriate.

### Embodiment 9

The method of Embodiment 1, in which there is a mechanism for transmitting the message that the input is inappropriate to the Display Unit, if the Answer Finding Component finds the input to be inappropriate.

### Embodiment 10

The method of Embodiment 1, in which there is a method of creating a corpus of documents relevant to the input question, either by retrieving such documents from a larger collection of documents, such as found on the World Wide Web; or retrieving such documents from a pre-assembled collection of documents stored on a remote database accessible to the Answer Finding Component.

### Embodiment 11

The method of Embodiment 1, in which there is a method in the Answer Finding Component for retrieving an answer to the input question from the corpus of documents.

### Embodiment 12

The method of Embodiment 1, in which there is a mechanism by which the Answer Finding Component can transmit the answer to the Display Unit.

This disclosure has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method for advertising, the method comprising:
(a) displaying an advertisement, wherein the advertisement is operable to receive an input;
(b) receiving an input;
(c) in response to the receiving, determining whether the input is appropriate; and
in response to determining that the input is appropriate, determining a response to the input based on a plurality of information in a digital repository.

2. The method according to claim 1, wherein the advertisement is a digital advertisement.

3. The method according to claim 1, wherein the input is a question in one of text and audio form, and the response is an answer to the question.

4. The method according to claim 1, wherein an input is appropriate when obscene, hateful or irrelevant to the product or service that is a subject of the advertisement.

5. The method according to claim 1, wherein the determining a response comprises transmitting the input to a remote server, wherein the remote server is the digital repository operable to maintain the plurality of information.

6. The method according to claim 5, wherein the plurality of information includes a collection of documents with answers.

7. The method according to claim 1, wherein the displaying and the receiving is performed by a user equipment (UE) having a processor, a memory storing computer program instructions, a display, a user input device, and is operable to transmit and receive data by wired or wireless means.

8. The method according to claim 7, wherein the UE is at least one of a mobile phone, a cell phone, a smart phone, a laptop, a tablet, a desktop computer, a personal computer, and an electronic device.

9. The method according to claim 1, wherein the determining is performed by one of a server, a computer each having a processor, a memory storing computer program instructions, operable to transmit and receive data by wired or wireless means.

10. The method according to claim 1, the method further comprising displaying the determined response.

11. An apparatus comprising at least one processor and a memory storing computer program instructions executable by the at least one processor, wherein the memory with the computer program instructions and the processor are configured to cause the apparatus to at least:
(a) display an advertisement, wherein the advertisement is operable to receive an input;
(b) receive an input;
(c) in response to the receiving, determining whether the input is appropriate; and
in response to determining that the input is appropriate, determining a response to the input based on a plurality of information in a digital repository.

12. The apparatus according to claim 11, wherein the advertisement is a digital advertisement.

13. The apparatus according to claim 11, wherein the input is a question in one of text and audio form, and the response is an answer to the question.

14. The apparatus according to claim 11, wherein an input is appropriate when obscene, hateful or irrelevant to the product or service that is a subject of the advertisement.

15. The apparatus according to claim 11, wherein the determining a response comprises transmitting the input to a remote server, wherein the remote server is the digital repository operable to maintain the plurality of information.

16. The apparatus according to claim 15, wherein the plurality of information includes a collection of documents with answers.

17. The apparatus according to claim 11, wherein the apparatus is one of a mobile phone, a cell phone, a smart phone, a laptop, a tablet, a desktop computer, a personal computer, and an electronic device.

18. The apparatus according to claim 11, the memory with the computer program instructions and the processor further cause the apparatus to display the determined response.

19. A non-transitory computer-readable medium tangibly storing computer program instructions which when executed by a processor, cause the processor to at least:
(a) display an advertisement, wherein the advertisement is operable to receive an input;
(b) receive an input;
(c) in response to the receiving, determining whether the input is appropriate; and
in response to determining that the input is appropriate, determining a response to the input based on a plurality of information in a digital repository.

20. The non-transitory computer-readable medium according to claim 19, wherein the advertisement is a digital advertisement.
